(19) United States
(12) Patent Application Publication
(10) Pub. No.: US 2013/0151332 A1
(43) Pub. Date: Jun. 13, 2013

(54) ASSISTED ADJUSTMENT OF AN ADVERTISING CAMPAIGN

(71) Applicants: Rong Yan, Mountain View, CA (US); Nuwan Senaratna, Sunnyvale, CA (US)

(72) Inventors: Rong Yan, Mountain View, CA (US); Nuwan Senaratna, Sunnyvale, CA (US)

(21) Appl. No.: 13/316,493

(22) Filed: Dec. 10, 2011

(51) Int. Cl. G06Q 30/02

(52) U.S. Cl. 705/14.42; 705/14.49; 705/14.43; 705/14.66

(57) ABSTRACT

An ad publishing system provides ads of an advertiser's advertising campaign to a target group specified by initial targeting criteria. The publishing system evaluates results of advertising metrics for various segments of the target group based on user reactions to the initial presentation of the ads. Based on the advertising metric results for the various segments, the publishing system suggests to the advertiser a modification of the advertising campaign. Possible modifications to the advertising campaign include narrowing the initial targeting criteria to specify at least one of the segments as the target group, specifying a different ad for a low-performing segment, and adjusting the value of a bid for display of the ads in the campaign.

### BACKGROUND

The present invention generally relates to the field of electronic advertising, and more specifically, to automated or semi-automated techniques for revising an advertising campaign based on an initial set of advertising results.

Companies and other organizations advertising electronically typically do so by submitting the ad or ads to an advertising publisher, which serves ads to be displayed in conjunction with content. As part of the submission of the ads to the advertising publisher, advertisers typically specify criteria defining a target group to which display of the ads will be limited, such as people of a specified gender, age group, location, or the like.

However, it may be difficult for the advertiser to accurately determine the target group that will be most receptive to the ads. Thus, in many cases advertisers specify only a very broad target group, such as males, or people between ages 20 and 40, or specify no target group at all, instead advertising to all users. Such broad target groups fail to account for the variations of user interest and taste within the group, thereby leading to advertising to significant numbers of users who have little interest in the advertisement. Conversely, advertisers may attempt to narrowly tailor the target group based upon their own assumptions about the interests of various types of users. However, the advertisers may guess poorly, thereby advertising to an audience that in fact has little interest in the advertisement. Further, narrow tailoring of the target group risks restricting the ads to an unduly small audience, meaning that the ads will be displayed relatively infrequently.

### SUMMARY

In embodiments of the invention, an ad publishing system provides ads of an advertiser's advertising campaign to a target group specified by initial targeting criteria. The publishing system evaluates values of advertising metrics for various segments (sub-groups) of the target group based on user reactions to the initial presentation of the ads. Based on the advertising metric values for the various segments, the publishing system suggests a modification of the advertising campaign to the advertiser. Possible modifications to the advertising campaign include narrowing the initial targeting criteria to specify at least one of the segments as the modified target group, specifying a different ad for a low-performing segment, and adjusting the value of a bid for display of the ads in the campaign.

In one embodiment, the publishing system employs a top-down approach to suggesting modifications to the advertising campaign, including identifying a divergence in advertising metric values between different values of one of the attributes associated with the targeting criteria, such as a divergence between males and females. The publishing system can then suggest various modifications of the campaign, such as excluding the segment entirely from the targeting criteria, or specifying a new ad for a segment defined by low-performing attribute values.

In another embodiment, the publishing system employs a bottom-up approach to suggesting modifications to the advertising campaign, including selecting the attributes and attribute values to analyze, forming combinations of the selected attribute values, and calculating advertising metrics for each of the combinations. The publishing system further clusters the combinations based on the values of their corresponding advertising metrics, presents the advertiser with the metrics for various ones of the clusters (e.g., the top clusters), and provides campaign modification suggestions based on the cluster metrics. Possible suggestions include specifying whether to exclude or include a given cluster in the target group for the ad campaign, specifying a new ad for a given cluster, and the like.

The features and advantages described in the specification are not all inclusive and, in particular, many additional features and advantages will be apparent to one of ordinary skill in the art in view of the drawings, specification, and claims. Moreover, it should be noted that the language used in the specification has been principally selected for readability and instructional purposes, and may not have been selected to delineate or circumscribe the inventive subject matter.

### BRIEF DESCRIPTION OF DRAWINGS

FIG. 1 is a high-level block diagram of a computing environment in which digital advertisements are displayed and evaluated, according to one embodiment.

FIG. 2 illustrates an example user interface used by an advertiser to define an advertising campaign for submission to the ad publisher, according to one embodiment.

FIG. 3 illustrates a process for modifying an advertising campaign based on feedback from an ad publisher about the performance of the ad for various user segments, according to one embodiment.

FIG. 4A illustrates an example user interface used in a top-down approach, detecting a divergence in advertising metric values based on gender, according to one embodiment.

FIG. 4B illustrates a user interface used in a bottom-up approach to modifying an ad campaign, according to one embodiment.

FIG. 5 illustrates steps performed by the ad publisher as part of a bottom-up approach to modifying an ad campaign, according to one embodiment.

FIG. 6 illustrates steps performed by the ad publisher when suggesting an ad for use with a given target group, according to one embodiment.

The figures depict embodiments of the present invention for purposes of illustration only. One skilled in the art will readily recognize from the following description that alternative embodiments of the structures and methods illustrated herein may be employed without departing from the principles of the invention described herein.

### DETAILED DESCRIPTION

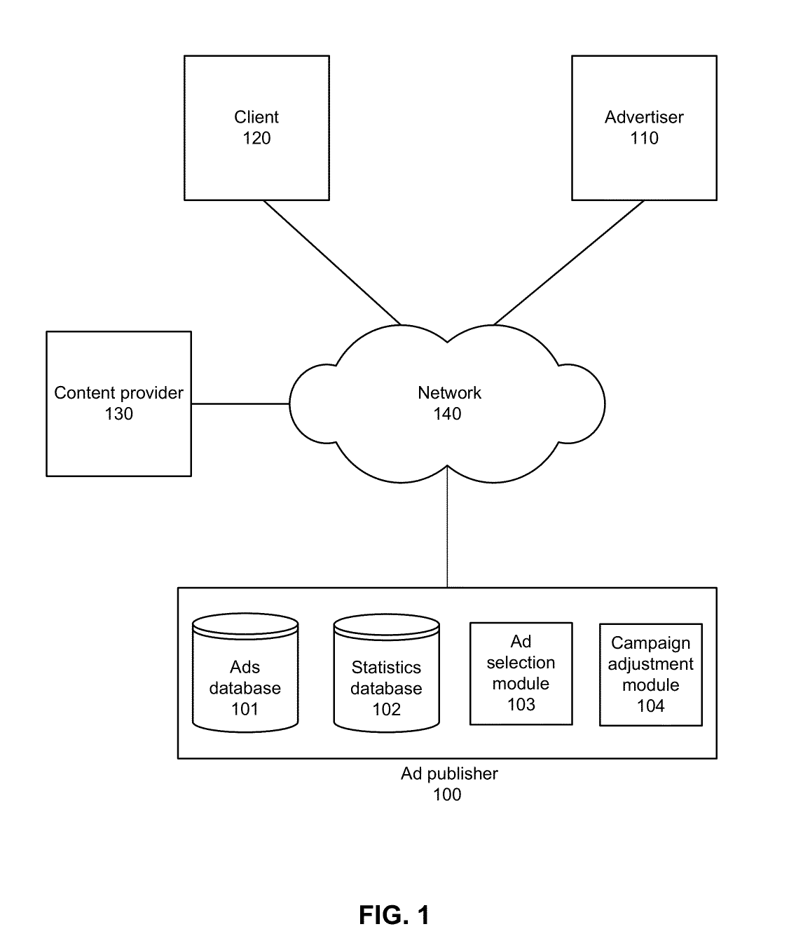

FIG. 1 is a high-level block diagram of a computing environment in which digital advertisements are displayed and evaluated, according to one embodiment. Specifically, FIG. 1 illustrates a client device 120, a network 140, a content provider 130, an advertiser 110, and an ad publisher 100. The client 120 views digital content provided over the network 140 by the content provider 130, such as data of a social networking system, digital video, web pages, and the like. The advertiser 110 contracts with the ad publisher 100 to provide advertisements of its ad campaign for display in conjunction with content provided by the various content providers 130, in exchange for payment by the advertiser. Similarly, the content provider 130 allows the ad publisher 100 to provide advertisements for display in conjunction with its content, in exchange for payment by the ad publisher.

In one embodiment, the content provider 130 and the ad publisher 100 constitute a single system, and/or are administered by the same organization. For example, in the case of the social networking system, such as that provided by FACEBOOK, INC., the social networking system can both provide content to the clients 120 and also select advertisements to display in conjunction with the content.

More specifically, the client devices 120 may be any one of a variety of different computing devices. Examples of client devices 120 include personal computers, mobile phones, smart phones, laptop computers, tablet computers, and digital televisions or television set-top boxes with Internet capabilities.

The network 140 is typically the Internet, but may also be any network, including but not limited to a LAN, a MAN, a WAN, a mobile, wired or wireless network, a private network, or a virtual private network.

The content provider 130 may be any system capable of serving digital content to the client 120, such as a social networking system, a video hosting service, a blogging website, or the like. The content provider 130 displays advertisements provided by the ad publisher 100 in conjunction with its content.

The advertiser 110 represents any business or other organization advertising electronically via the ad publisher 100. The advertiser 110 provides ad campaign data to the ad publisher 100. The ad campaign data includes one or more ads to be displayed and optional targeting criteria defining a group of users to whom the ads are to be displayed. The targeting criteria may either be explicitly specified by the advertiser 110, or maybe implicit based on a lack of specified targeting criteria (e.g., the value “All users,” an implicit criterion resulting from the advertiser failing to specify any explicit targeting criteria).

The targeting criteria may specify values for one or more attributes that can characterize a user, such as user age, gender, geographic location of residence, hobbies (e.g., “tennis” or “English literature”), languages spoken, education level, relationship status, and the like. Values for such attributes may be specified directly by the users themselves, such as in the online profile of a social networking system. Alternatively, the values may be inferred based on other data associated with the user, e.g., inferring the user's age or gender based on content viewed by the user, characteristics of the user's friends on a social networking system, and the like. Other possible attributes for use within targeting criteria include relationship data from the social graph of a social networking system (e.g., the number of friends, or the attributes of the friends), and/or online actions, such as web pages viewed, or actions within a social networking system (e.g., items for which the user expressed approval or “liked,” groups belonged to, etc.).

In one embodiment, the targeting criteria of the ad campaign data can include not only attributes of the users to whom ads are to be presented, but also attributes of the content in conjunction with which the ads are presented. For example, the targeting criteria may specify keywords or topics associated with the content, such as “gardening” or “pets.” The keywords or topics may be specified by the content owners themselves, e.g., as metadata of web pages embodying the content. Alternatively, they may be inferred, e.g., by application of classifier models generated through machine learning processes that label content with topics or keywords.

Each ad in the ad campaign may have an associated bid, which represents the amount to be paid by the advertiser 110 to the ad publisher 100 if a required payment condition is met. The payment condition can be specified by the advertiser 110 for each individual advertisement or for the ad campaign as a whole, and may include conditions such as display of the ad, a user clicking on or otherwise selecting the ad, a user purchasing a product associated with the ad, a user responding positively to a poll associated with the ad or an organization associated with the ad, or the like.

The ad publisher 100 receives and stores advertisements from advertisers 110, identifies which of the stored advertisements would be most appropriate for display in conjunction with the content of the different content providers 130, and provides the identified advertisements to the clients 120 for display. The ad publisher 100 provides an interface, such as a graphical user interface, that permits the advertisers 110 to define ad campaigns that contain one or more ads, optionally along with indications of a target group to which a given ad, or all of the ads, are to be displayed.

More specifically, the ad publisher 100 comprises an ads database 101, a statistics database 102, an ad selection module 103, and a campaign adjustment module 104.

The ads database 101 stores the details of the advertising campaigns specified by the advertisers 110. For example, a particular advertiser 110 might submit an ad campaign having ten ads, each of which may be displayed to a target group, such as males aged 20-40. In this case, the ads database 101 would store each of the ten ads, the targeting criteria defining the target group, and an indication that each of the ten ads is associated with the target group. In some embodiments, the ads database 101 also stores the ad bid of the advertiser 110 and an indication of the advertiser condition upon which payment is conditioned, such as a user clicking on the ad.

The ads may be of a number of different types, such as textual ads, image ads, or video ads. Further, each ad may have corresponding requirements regarding the manner in which it is displayed, such as in a page banner, in a sidebar, as a link in a set of search results, and the like.

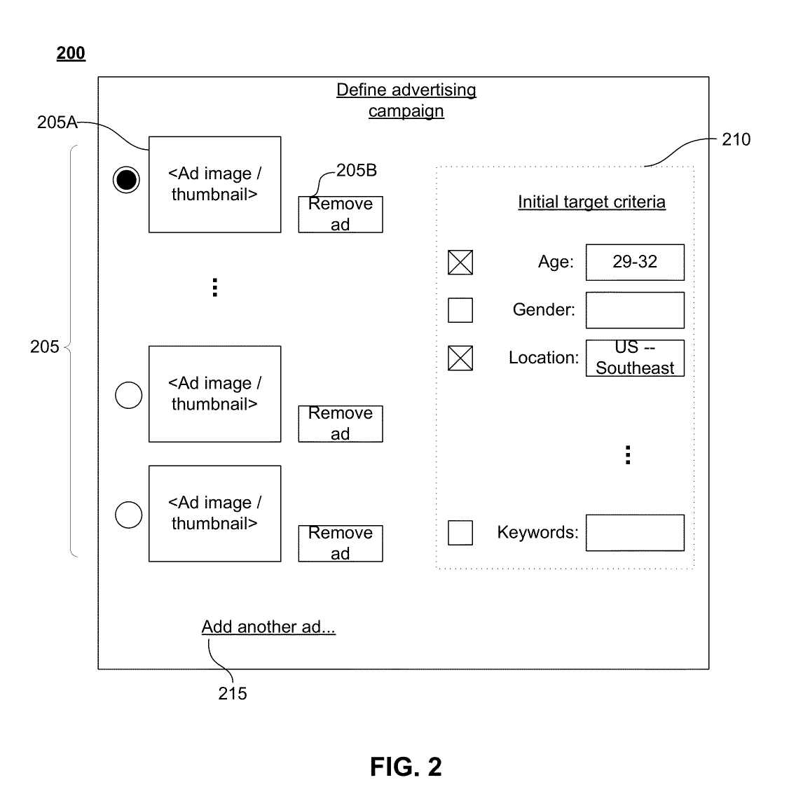

FIG. 2 illustrates an example user interface 200 used by an advertiser 110 to define an advertising campaign for submission to the ad publisher 100. In one embodiment, the user interface 200 is a web-based interface accessed via a browser of the advertiser 110. The user interface 200 comprises a set of ad selection controls 205, each corresponding to a different advertisement and including a preview area 205A showing a graphical representation of the ad (e.g., a thumbnail image) and an ad removal control for removing the corresponding ad from the campaign. An advertisement adding control 215 can be used to add another ad to the campaign (e.g., via a conventional file open dialog box).

The example user interface 200 further includes a set of controls 210 for specifying an initial set of targeting criteria. In some embodiments, the targeting criteria apply to each of the specified ads. In other embodiments, each of the ads may have separate targeting criteria, with the displayed settings of the targeting criteria controls 210 applying only to the currently selected ad. Although the controls 210 depicted in FIG. 2 only include controls for specifying age, gender, location, and keyword attributes, it is appreciated that the controls may specify any attribute pertaining to the ad audience or the content in conjunction with which the ad is displayed, such as hobbies, relationship status, actions of friends in a social networking system, and the like.

Referring again to FIG. 1, the statistics database 102 stores statistics on interactions of users of the clients 120 with the advertisements displayed along with the content of the content providers 130. The statistics include values of at least one advertising metric quantifying the effectiveness of the ad to which it applies. Different advertising metrics may include, for example, for each ad, a total number of times that the ad was presented to users, or a click-through rate (CTR) indicating the percentage of the time that users clicked on or otherwise selected the ad with respect to the number of times that the ad was presented to the users. In some embodiments, advertising metrics are tracked on a per-user basis, as well as on a per-ad basis, thus specifying how effective a particular ad was for a particular user, and not merely for users in the aggregate. Likewise, the advertising metric could be a conversion rate indicating the percentage of the time that display of the ad resulted in some specified action, such as purchase of a product corresponding to the ad. The advertising metric could also be the result of a poll associated with a brand or organization associated with the ad, such as a measurement of “brand lift” as evidenced by a poll result indicating positive name recognition of the brand or organization. Additionally and/or alternatively, the statistics could be tracked with respect to the ad campaign as a whole, rather than (or in addition to) the individual ads within the ad campaign.

The ad selection system 103 selects, for the content of the given content provider 130, an appropriate ad from the ads database 101. In one embodiment, the ad is selected based on the expected revenue generated by the ad, where the expected revenue is the product of the advertisement bid of the advertiser 110 and the probability that the payment condition will be satisfied if the advertisement is displayed. That is, for given content of a content provider 130, and for the user of the client 120 viewing that content, the ad publisher 100 can compute the expected revenue of each ad. Then, the ad publisher 100 can select, as the ad (or ads) to display in association with the content, the ad(s) having the highest expected revenue.

For many types of payment conditions—such as clicking on the ad or buying a product associated with the ad—the more precise the targeting criteria associated with a particular ad, the greater the probability of satisfaction of the payment condition, and hence the greater the expected revenue for display of the ad. As one example, an ad related to Social Security benefits would tend to be clicked on more frequently by users of older age groups, and hence targeting the ad to the older age groups would tend to increase the probability of satisfying a “click-on-ad” payment condition. Thus, it is beneficial to the ad publisher 100, as well as to the advertiser 110, to specify more precise targeting criteria for an ad.

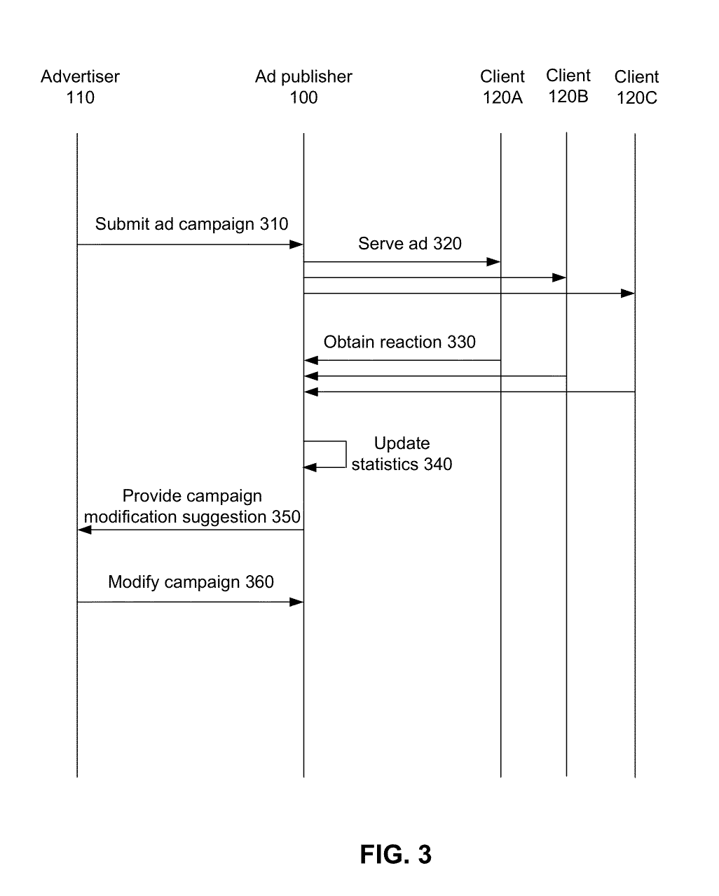

The campaign adjustment module 104 executes the initial ad campaign for some period of time, tracking advertising metrics and other statistics of the effectiveness of the ads to different groups of users. Based on the statistics, the campaign adjustment module 104 automatically or semi-automatically modifies the campaign to enhance its effectiveness, such as by changing the targeting criteria for ads within the campaign, by adding or removing ads from the campaign, by adjusting the bids for the ads in the campaign, or the like. The actions of the campaign adjustment module 104 are illustrated in more detail in FIG. 3.

Although for simplicity only one client 120, advertiser 110, content provider 130, network 140, and ad publisher 100 are illustrated in FIG. 1, it is understood that there may be any number of each. For example, there may be very large numbers (e.g., millions) of client devices 120 in communication with similarly large numbers of different content providers 130. Likewise, there may be many different advertisers using the same ad publisher 100.

FIG. 3 illustrates a process for modifying an advertising campaign based on feedback from an ad publisher 100 about the performance of the ad for various user segments. The advertiser 110 first submits 310 the data describing the ad campaign—such as the ads, the targeting criteria, the bids, etc.—to the ad publisher 100, which stores the data in the ads database 101. The ad selection module 103 of the ad publisher 100 then serves 320 the ad(s) of the ad campaign to users of the clients 120, such as in response to the ad(s) having the greatest expected revenue for given content and given users. The ads are served 320 over some period of time, such as a fixed period of time (e.g., two days, one week, etc/), or a variable length period of time sufficient to obtain some minimum amount of statistics (e.g., 1,000 ad impressions).

The ad publisher 100 obtains 330 reactions of the users associated with the provided ads, such as clicks or other selections of the ads, purchases of items associated with the ads, answers to polls influenced by the ads, and the like. On the basis of the obtained reactions, the campaign adjustment module 104 updates 340 the statistics database 102. The updating of the statistics database 102 includes calculating advertising metrics relevant to the payment conditions of the ads, such as the click-through rate of the ad, the conversion rate of the ad relative to some actions such as product purchase, the percentage of favorable reactions to a given poll, and the like.

In one embodiment, the statistics are calculated separately for different groups, either with respect to the value of a single attribute or a combination of multiple attribute values. For example, statistics may be calculated separately for the single demographic attribute “gender” (e.g., by separately tracking statistics for males and females within the group), or for the single demographic attribute “age” (e.g., by separately tracking statistics for each of a set of distinct age segments, such as individual years, or ranges of years such as ages 13-17, 18-22, 23-27, etc.). As another example, statistics may be calculated for combinations of the attributes “gender” and “age,” such as the segments <male, 13-17>, <female, 13-17>, <male, 18-22>, <female, 18-22>, etc.

In one embodiment, only attribute values within the group defined by the initial targeting criteria are considered. For example, if the initial targeting criteria limit the target group to females in general, or to females over age 30 located in the western United States, statistics are not tracked for segments containing males. In other embodiments, statistics may be tracked for segments with attribute values falling outside of the initial targeting criteria, as well.

Based on the updated statistics, the campaign adjustment module 104 provides 350 campaign modification suggestions related to various options. The campaign modification options include narrowing or otherwise adjusting the initial targeting criteria to define a group empirically determined to be more receptive to the campaign's ads than the initial target group. Other possible options include adding or removing ads from the campaign, and/or altering the ads with different targeting criteria. Another option is to raise (or lower) the bid for one or more of the ads in the ad campaign. If the advertiser 110 confirms the suggested modification option, the campaign is modified 360 accordingly. The various options for modifying campaigns are now described in more detail.

As previously noted, one of the options for modifying an ad campaign is adjusting the initial targeting criteria. In one embodiment, a top-down approach is employed. In the top-down approach, the campaign adjustment module 104 observes the values of the advertising metrics in the statistics database 102 as they are computed based on reactions of users of the clients 120 to the provided ads and notes any divergences occurring with respect to the advertising metric values across values of one of the attributes. A divergence may be considered to have occurred where the advertising metric values differ by at least some threshold amount, e.g., where one value is at least some predetermined constant multiple of the other, such as three times as much. The campaign adjustment module 104 then informs the advertiser 110 of the divergence and provides the option for the user to adjust the campaign. One option is to exclude the segment of users for lower-performing values of the attribute for which there is divergence. This revises the targeting criteria to be more narrow with respect to the diverging attribute. Another option is to change the ad to be displayed to that segment. This effectively splits the targeting criteria into two sets of targeting criteria, one original set associated with the initial targeting criteria and the initial ad(s), and a new se associated with the new ad(s). The new set of targeting criteria has the same settings as the initial targeting criteria, with the addition of an exclusion of users having the underperforming attribute value. Another option is to increase the bid for the ad when displayed to that segment.

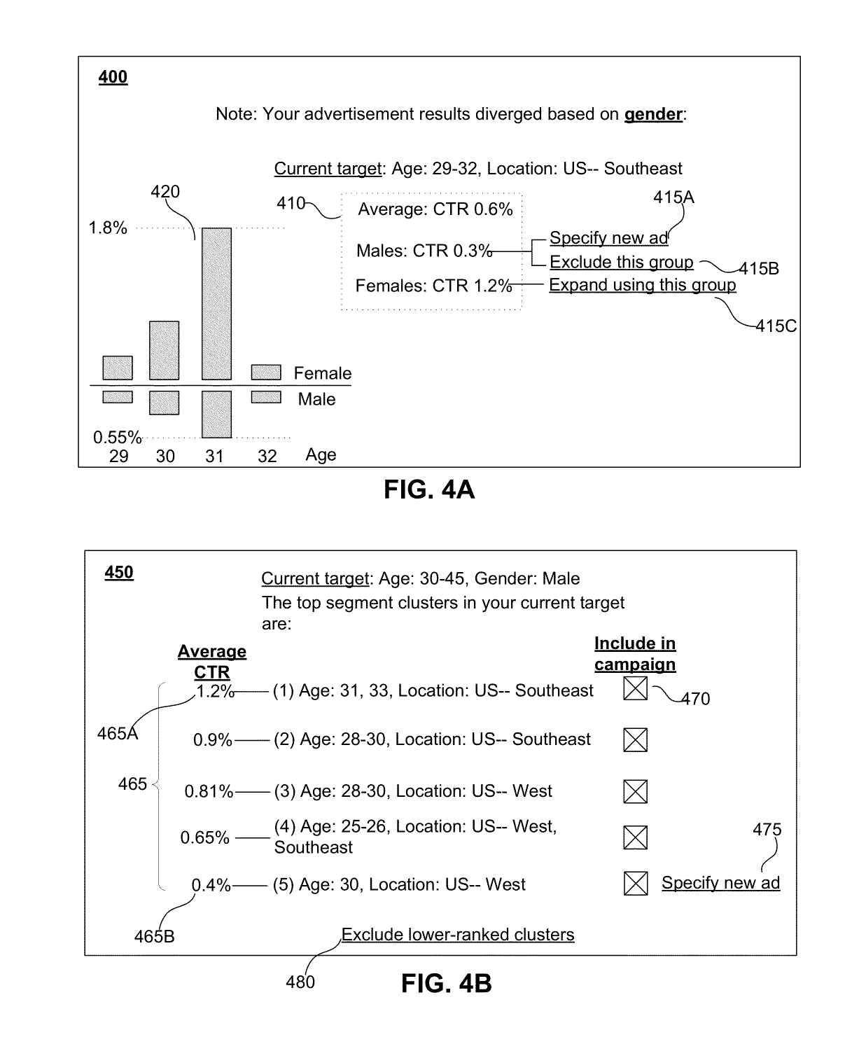

For example, FIG. 4A illustrates an example user interface 400 used in a top-down approach, detecting a divergence in advertising metric values based on gender, according to one embodiment. Assume for the purposes of this example that the initial targeting criteria of the advertiser 110 for the ad campaign specified people of ages 29-32 located in the southeastern United States. The user interface 400 specifies the attribute that was the source of the divergence (“Note: Your advertisement results diverged based on gender”) and the initial targeting criteria (“Current target: Age: 29-32, Location: US—Southeast”). The display area 410 summarizes the divergence with respect to the attribute. Namely, with respect to the gender attribute, the ads in the advertising campaign had a click-through rate of 0.3% for males and 1.2% for females, whereas the average click-through rate for the advertising campaign as a whole was 0.6%. The user interface 400 may illustrate additional data for visualizing the divergence, such as the multi-attribute distribution graph 420, which visually depicts the difference in click-through rates between males and females of different age groups within the current targeting criteria.

Suggested option 415A visually associated with the underperforming “males” segment provides the advertiser 110 with the option to specify a new ad, other than the ad(s) already associated with it. For example, if the advertising campaign includes two ads, either of which may be shown to users in the depicted target demographic group (i.e., users aged 29-32 and located in the southeast of the United States), selecting this option would effectively partition the targeting criteria into two distinct sets of criteria: an original set with the initial criteria (i.e., age=29-32, and location=southeast of U.S.), and a new set also excluding users with the underperforming “male” value of the “gender” attribute (i.e., age=29-32, and location=southeast of U.S., and gender=not male). Further, the group defined by the new set of criteria will be associated with the new specified ad(s), rather than the initial two ads that resulted in a low CTR.

Suggested option 415B visually associated with the underperforming “males” segment provides the advertiser 110 with the option to narrow the targeting criteria to exclude that group from future presentations of the advertisement. Thus, in the current example the targeting criteria would then become “age=29-32, and location=southeast of U.S., and gender=not male.” Alternatively, option 415C visually associated with the high-performing “females” segment provides the advertiser 110 with the option to specialize the targeting criteria in terms of the “females” value of the “gender” attribute, possibly broadening the targeting criteria with respect to other attributes. For example, targeting criteria “age=29-32, and location=southeast of U.S.” could be narrowed to include only the value “female” for the “gender” attribute, but broadened to remove restrictions regarding the “age” or “location” attributes. In one embodiment, the various broadening options—e.g., the option to remove the on the “age” or “location” attributes—are suggested in response to the user selecting option 415C.

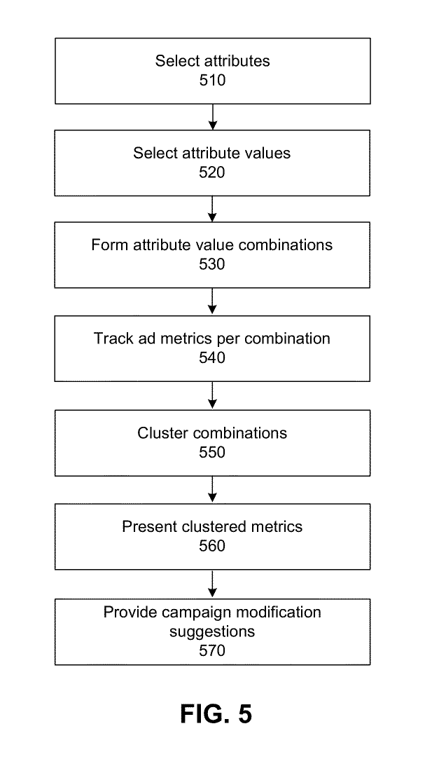

Another technique for modifying an ad campaign by adjusting the initial targeting criteria is to use a bottom-up approach, steps of which are illustrated in FIG. 5. The campaign adjustment module 104 selects 510 some set of the possible attributes for analysis, and selects 520 some set of the possible values of those attributes, for analysis. The attributes and attribute values may be from a predetermined set of known importance, or they may be dynamically computed, e.g., by analyzing which attributes and attribute values have been observed to lead to particularly strong or weak advertising metric values. Using the selected attributes and attribute values, the campaign adjustment module 104 forms 530 attribute value combinations of different possible values of the selected attributes and tracks 540 statistics for each of the combinations. The campaign adjustment module 104 then clusters 550 the combinations into groups based on degrees of similarity between the advertising metric, such as similarity of click-through rates, and computes an average value of the advertising metric for each cluster. The campaign adjustment module 104 presents 560 the tracked statistics to the advertiser 110 and provides 570 suggestions for modifying the ad campaign. In one embodiment, the advertiser 110 is has the option to provide input into this process, such as by partially or completely specifying the attributes and attribute values to be tracked.

For example, the campaign adjustment module 104 might select 510 the attributes age, gender, and location, and further select 520 the age values in 1-year age ranges, the gender values being “male” and “female”, and the location values being some set of regions, such as “United States—Southeast”, “United States—West”, “Canada—Quebec”, or the like. The campaign adjustment module 104 then forms 530 attribute value combinations such as <Age=13, Gender=Male, Location=United States—Southeast>, <Age=13, Gender=Female, Location=United States—Southeast>, <Age=13, Gender=Male, Location=United States—West>, and the like. The campaign adjustment module 104 then tracks statistics for each of these distinct combinations, associating a given reaction to an ad with the combination (if any) for which the user has all of the corresponding attribute values. For example, if a user whose profile indicated that he was 17 years old, male, and located in Santa Clara, Calif. (i.e., western United States), clicked on one of the ads in the ad campaign of an advertiser 110, then the click-through data would be associated with the <Age=17, Gender=Male, Location=United States—West> combination.

To continue the example, assume that click-through rate is the advertising metric of interest, and that seven of the attribute value combinations have the respective click-through rates 0.6%, 0.5%, 0.25%, 0.61%, 1.2%, 0.21%, and 0.53%, respectively. Starting with the first combination as a cluster seed, and assuming a similarity threshold of 0.05% from the cluster center as the requirement for being within the same cluster, the combinations would be clustered 550 into groups {0.6%, 0.61%}, {0.5%, 0.53%}, {0.25%}, {1.2%}, and {0.21%}, with average CTRs of 0.605%, 0.515%, 0.25%, 1.2%, and 0.21%, respectively.

The campaign adjustment module 104 then presents 560 the statistics. For example, FIG. 4B illustrates one sample user interface 450 for this purpose. In addition to indicating the target group defined by the current targeting criteria (i.e., males aged 30-45), the user interface 450 also includes a listing 465 of the top clusters of segments of the target group, sorted according to values of the advertising metric of interest (here, average CTR). For example, the first and highest-ranked cluster 465A contains the combinations <Age=31, Gender=Male, Location=US—Southeast> and <Age=33, Gender=Male, Location=US—Southeast>, the average CTR of which is 1.2%.

Campaign modification suggestions are presented 570 in association with one or more of the clusters in the listing 465. For example, each of the clusters can have an associated checkbox 470 or other control used to indicate whether that cluster should be included in, or excluded from, the target group. De-selection of the checkbox 470 causes the targeting criteria to be revised to exclude the segments in the corresponding cluster. Further, one or more of the clusters may have an associated link 475 that permits the advertiser 110 to specify a new advertisement specific to the segments of that cluster, similar to the option 415A mentioned above with respect to FIG. 4A. The user interface 450 may also include an option 480 to exclude the segments of any clusters ranked lower than the top set of clusters shown in the listing 465, thus resulting in a revision of the targeting criteria.

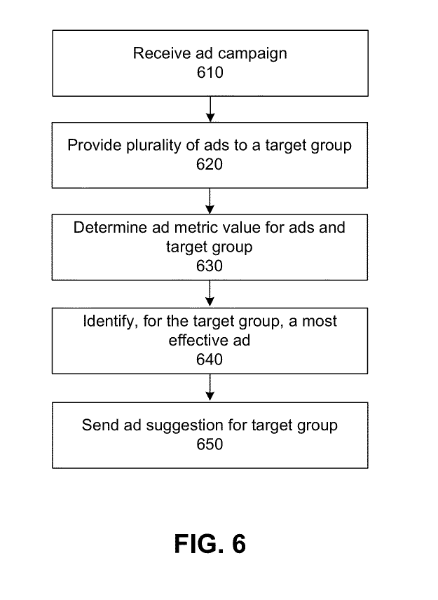

The campaign adjustment module 104 may additionally be used to select the best ads of a campaign to use for particular target demographics, as illustrated in FIG. 6. First, the ad publisher 100 received from the advertiser 110 a definition of the advertising campaign. The ad campaign can have a plurality of ads, e.g., as specified in the user interface 200 of FIG. 2, and target criteria can be assigned to the ads individually or as a whole. The plurality of ads can represent different views, or different messages, of the overall campaign and thus may appeal to somewhat different audiences. Thus, for any given target group of interest, different ones of the ads may be appropriate.

The target group (e.g., males, people between ages 20 and 30, or the like) may be explicitly specified by the advertiser 110. Alternatively, the ad publisher 100 may automatically form a plurality of segments, such as in the bottom-up approach described above with respect to FIGS. 4B and 5, and each of these segments may be individually evaluated as the target group.

In either case, the ad publisher 100 provides 620 the plurality of ads of the ad campaign to users of the target group, and determines 630 advertising metric values for the different ads in the target group. The ad publisher 100 then identifies 640, for the target group, an ad (or ads) that is most effective based on the values of the advertising metric, such as an ad having the highest value of the advertising metric. The ad publisher then sends 650 to the advertiser 110 a suggestion to display, as the ad(s) for the target group, the identified most effective ad(s), and to exclude other ads from display to the target group.

Thus, in the various ways discussed above, the suggestions of the campaign adjustment module 104 permit advertisers 110 to quickly and easily determine ways to improve the effectiveness of their advertising campaigns.

The foregoing description of the embodiments of the invention has been presented for the purpose of illustration; it is not intended to be exhaustive or to limit the invention to the precise forms disclosed. Persons skilled in the relevant art can appreciate that many modifications and variations are possible in light of the above disclosure.

Some portions of this description describe the embodiments of the invention in terms of algorithms and symbolic representations of operations on information. These algorithmic descriptions and representations are commonly used by those skilled in the data processing arts to convey the substance of their work effectively to others skilled in the art. These operations, while described functionally, computationally, or logically, are understood to be implemented by computer programs or equivalent electrical circuits, microcode, or the like. Furthermore, it has also proven convenient at times, to refer to these arrangements of operations as modules, without loss of generality. The described operations and their associated modules may be embodied in software, firmware, hardware, or any combinations thereof.

Any of the steps, operations, or processes described herein may be performed or implemented with one or more hardware or software modules, alone or in combination with other devices. In one embodiment, a software module is implemented with a computer program product comprising a computer-readable medium containing computer program code, which can be executed by a computer processor for performing any or all of the steps, operations, or processes described.

Embodiments of the invention may also relate to an apparatus for performing the operations herein. This apparatus may be specially constructed for the required purposes, and/or it may comprise a general-purpose computing device selectively activated or reconfigured by a computer program stored in the computer. Such a computer program may be stored in a non-transitory, tangible computer readable storage medium, or any type of media suitable for storing electronic instructions, which may be coupled to a computer system bus. Furthermore, any computing systems referred to in the specification may include a single processor or may be architectures employing multiple processor designs for increased computing capability.

Embodiments of the invention may also relate to a product that is produced by a computing process described herein. Such a product may comprise information resulting from a computing process, where the information is stored on a non-transitory, tangible computer readable storage medium and may include any embodiment of a computer program product or other data combination described herein.

Finally, the language used in the specification has been principally selected for readability and instructional purposes, and it may not have been selected to delineate or circumscribe the inventive subject matter. It is therefore intended that the scope of the invention be limited not by this detailed description, but rather by any claims that issue on an application based hereon. Accordingly, the disclosure of the embodiments of the invention is intended to be illustrative, but not limiting, of the scope of the invention, which is set forth in the following claims.

What is claimed is:

1. A computer-implemented method comprising:
receiving, at a publishing system from an advertiser, data for an advertising campaign comprising an initial ad and targeting criteria defining an initial target group for receiving the initial ad;
providing the initial ad for display to a plurality of users in a plurality of segments of the initial target group;
determining, by the publishing system, a value of an advertising metric for a first one of the plurality of segments based on the display of the initial ad to the users of the first segment;
based on the value of the advertising metric, determining by the publishing system a suggestion for the advertiser to modify the targeting criteria to remove the first segment from the targeting criteria to be used for the initial ad; and
sending the suggestion from the publishing system to the advertiser.

2. The computer-implemented method of claim 1, further comprising:
responsive to receiving confirmation of the advertiser to the suggestion, forming a modified target group by modifying the targeting criteria to remove the first segment from the initial target group; and
providing the initial ad for display to a plurality of users in the modified target group.

3. The computer-implemented method of claim 1, further comprising:
prompting the advertiser to specify a first ad different from the initial ad for the first segment; and
providing the first ad for display to a plurality of users of the first segment.

4. The computer-implemented method of claim 3, further comprising:
providing the initial ad solely to a portion of the initial target group that excludes the first segment.

5. The computer-implemented method of claim 1, wherein the targeting criteria define a group consisting of all users.

6. The computer-implemented method of claim 1, wherein the advertising metric is selected from a group consisting of: a click-through rate, a conversion rate, and a brand lift measurement.

7. The computer-implemented method of claim 1, wherein the targeting criteria include a value for each of a plurality of attributes, the method further comprising:
identifying a divergence in values of the advertising metric between a first value and a second value of an additional attribute not already in the plurality of attributes of the targeting criteria; and
responsive to the first value being lower between the second value, identifying, as the first segment, a segment of the target group defined in part by the first value.

8. The computer-implemented method of claim 1, further comprising:
selecting a plurality of attributes used to characterize a user;
for each of the plurality of attributes, identifying a plurality of values of the attribute;
forming a plurality of combinations of the values of the attributes;
determining values of the advertising metric for each of the combinations;
forming a plurality of combination clusters by clustering the combinations according to similarity in the values of the advertising metric of the combinations;
identifying one of the combination clusters having a low average value of the advertising metric values of the combinations in the cluster; and
identifying, as the first segment to be removed, a group of users having the attribute values of the combinations in the identified combination cluster.

9. A computer-readable storage medium storing executable computer program instructions, comprising:
instructions for receiving, at a publishing system from an advertiser, data for an advertising campaign comprising an initial ad and targeting criteria defining an initial target group for receiving the initial ad;
instructions for providing the initial ad for display to a plurality of users in a plurality of segments of the initial target group;
instructions for determining, by the publishing system, a value of an advertising metric for a first one of the plurality of segments based on the display of the initial ad to the users of the first segment;
instructions for, based on the value of the advertising metric, determining by the publishing system a suggestion for the advertiser to modify the advertising campaign; and
instructions for sending the suggestion from the publishing system to the advertiser.

10. The computer-readable storage medium of claim 9, wherein the suggestion to modify the advertising campaign comprises modifying the targeting criteria to remove the first segment from the targeting criteria to be used for the initial ad.

11. The computer-readable storage medium of claim 9, wherein the suggestion to modify the advertising campaign comprises adjusting the bid for the initial ad with respect to the first segment.

12. The computer-readable storage medium of claim 9, wherein the suggestion to modify the advertising campaign comprises modifying the targeting criteria to remove the first segment.

13. The computer-readable storage medium of claim 12, further comprising instructions for providing the initial ad solely to a portion of the initial target group that excludes the first segment.

14. The computer-readable storage medium of claim 9, further comprising:
instructions for selecting a plurality of attributes used to characterize a user;
instructions for each of the plurality of attributes, identifying a plurality of values of the attribute;
instructions for forming a plurality of combinations of the values of the attributes;
instructions for determining values of the advertising metric for each of the combinations;
instructions for forming a plurality of combination clusters by clustering the combinations according to similarity in the values of the advertising metric of the combinations;
instructions for identifying one of the combination clusters having a low average value of the advertising metric values of the combinations in the cluster;
instructions for identifying, as a first segment to be removed, a group of users having the attribute values of the combinations in the identified combination cluster; and
instructions for sending a suggestion from the publishing system to the advertiser to modify the targeting criteria to remove the first segment.

15. A computer-implemented method comprising:
receiving, at a publishing system from an advertiser, data for an advertising campaign comprising a plurality of ads;
providing the plurality of ads for display to a plurality of users in an initial target group;
for each ad of a plurality of the ads, and for an advertising metric:
determining, by the publishing system for the ad, a value of the advertising metric for each of a plurality of segments of the target group; and
based on the determined values of the advertising metric, identifying by the publishing system, for each of the plurality of segments of the target group, a most effective ad.

16. The computer-implemented method of claim 15, further comprising:
sending, from the publishing system to the advertiser, a suggestion to assign the identified most effective ad for a first segment of the plurality of segments to the first segment; and
responsive to receiving confirmation of the advertiser to the suggestion to assign the identified most effective ad to the first segment:
providing the identified most effective ad to the first segment; and
refraining from providing other ones of the plurality of ads to the first segment.

17. The computer-implemented method of claim 15, further comprising:
providing, to a first segment of the plurality of segments, the identified most effective ad for the first segment; and
refraining from providing other ones of the plurality of ads to the first segment.

18. The computer-implemented method of claim 15, wherein the initial target group consists of all users.

19. The computer-implemented method of claim 15, wherein the advertising metric is selected from a group consisting of a click-through rate, a conversion rate, and a brand lift measurement.

20. A computer-implemented method comprising:
sending, by an advertiser to a publishing system, data for an advertising campaign comprising a plurality of ads and targeting criteria defining a target group to which to display the ads; and
receiving, by the advertiser from the publishing system, a suggestion of a most effective ad to display to a segment of the target group with respect to a given advertising metric; and
sending, by the advertiser to the publishing system, a confirmation of displaying the suggested ad to the segment.
